(19) United States
(12) Patent Application Publication
(10) Pub. No.: US 2006/0230107 A1
(43) Pub. Date: Oct. 12, 2006

(54) Method and computer-readable medium for multimedia playback and recording in a peer-to-peer network

(75) Inventors: Mingjian Yu, Beijing (CN); Han Fang, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development Co., Ltd., Beijing (CN)

(21) Appl. No.: 11/177,143

(22) Filed: Jul. 7, 2005

Related U.S. Application Data
(60) Provisional application No. 60/662,131, filed on Mar. 15, 2005.

(51) Int. Cl. G06F 15/16

(52) U.S. Cl. 709/204

(57) ABSTRACT

A method and computer-readable medium for storing content in a peer-to-peer network is provided. A client of a peer-to-peer network receives a plurality of data blocks that respectively include a portion of the content. One or more of the plurality of data blocks are pseudo-randomly selected. The selected data block is then stored. In other embodiments, a method and computer-readable medium for playing streaming content in a peer-to-peer network is provided. A desired playback position of the streaming content is obtained. A first sequence number of a current data block of the streaming content is obtained. An estimation of a second sequence number that corresponds to the desired playback position is made. A connection with a peer client having a data block with the second sequence number associated therewith is made and the data block is received from the peer client.

### RELATED APPLICATION DATA

This patent application claims the benefit of provisional U.S. Patent Application Ser. No. 60/662,231, filed Mar. 15, 2005.

### BACKGROUND

In a client-server network adapted to provide streaming multimedia data such as video or audio, many clients may participate in a video streaming session. The processing capacity of a media server in such a network is limited. If the number of clients connected to the media server exceeds the processing or transmission capacity of the server, the media server may be unable to provide a high quality of service to the clients, crash, discontinue service to clients, or refuse service or connection to clients.

Peer-to-peer networking solutions reduce or eliminate capacity deficiencies that are common in client/server network configurations. Peer-to-peer network technologies distribute processing and transmission demands among peer clients in the network. Thus, as a peer-to-peer network grows in size, so to does the processing and transmission capacity of the peer-to-peer network.

In streaming media broadcast scenarios, a client may join a streaming session at a time that does not coincide with the beginning of the streaming session. In such a situation, playback of the streaming session commences from a point in the streaming session corresponding to the time at which the client joined the broadcast. Playback of a streaming session from the point within the session at which the client joined the session is often undesirable from a user's perspective.

Moreover, a client in a peer-to-peer network may store content for distribution to other clients in the peer-to-peer network. However, a client's cache capacity is limited in size, and thus a client may be unable to store a complete streaming session that is larger than the client's cache capacity.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a peer-to-peer network that facilitates playback and recording of streaming multimedia data;

FIG. 2 is a diagrammatic representation of an embodiment of a streaming content file having content that may be distributed in a peer-to-peer network;

FIG. 3 is a diagrammatic representation of an embodiment of segmented streaming content formatted for transmission in a peer-to-peer network;

FIG. 4 is a diagrammatic representation of an embodiment of a software configuration that facilitates playback and recording of streaming multimedia data;

FIGS. 5A-5C are respective diagrammatic representations of an embodiment of randomized data block storage in clients of a peer-to-peer network;

FIG. 6 is a flowchart of an embodiment of a peer client processing routine for playback of streaming media content received in a peer-to-peer network;

FIG. 7 is a flowchart of an embodiment of peer client processing routine for caching received streaming content in a peer-to-peer network; and

FIG. 8 is a flowchart of an embodiment of a peer client processing routine for playback of streaming content from an arbitrary position of the streaming content in a peer-to-peer network.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

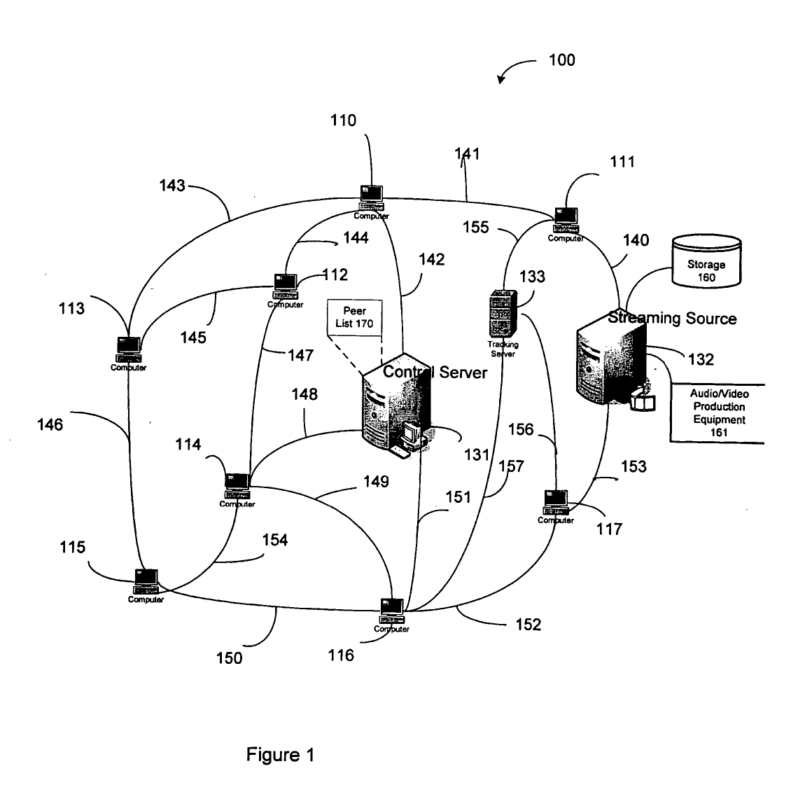

FIG. 1 is a diagrammatic representation of an embodiment of a peer-to-peer network 100 that facilitates playback and recording of streaming multimedia data. Network 100 includes various peer clients 110-117 that may be interconnected with other clients in network 100. Additionally, network 100 may include a control server 131, a streaming source 132, and a tracking server 133. One or more clients may connect with control server 131 and streaming source 132 in addition to other network clients. Clients 110-117 may connect with other network clients, control server 131, streaming source 132, and tracking server 133 by network connections 140-157, such as wire, wireless communication links, fiber optic cables, or other suitable network media.

Control server 131 may facilitate connection of new clients within network 100 and organize clients 110-117 that have joined network 100. Clients 110-117 may be implemented as data processing systems, such as personal computers, wired or wireless laptop computers, personal digital assistants, or other computational devices capable of network communications.

Streaming source 132 may be implemented as a server that stores or accesses streaming content, such as video, audio, or the like, and streams the data to one or more clients in network 100. For example, the streaming content may be retrieved from a file that is accessed by streaming source 132 from a storage device 160. Alternatively, the streaming content may be produced from, for example, audio/video production equipment 161 that is interfaced with streaming source 132. The streaming content may comprise data encoded in a native streaming format, such as RealAudio formatted files, RealVideo formatted files, ASF, or another streaming format that may be processed by a streaming media application, such as RealPlayer, Windows Media Player, or another streaming media application. The native formatted streaming content may be encapsulated in a network transport format that facilitates transmission of data among peer clients of network 100.

Tracking server 133 may be implemented as a data processing system that facilitates recording of the distribution of streaming content segments within network 100. For example, streaming source 132 may segment streaming content into data blocks that are distributed within network 100. Various clients 110-117 may receive and store different data blocks of the streaming content. In accordance with embodiments described herein, a client 110-117 may connect with tracking server 133 to report the particular data blocks stored by the client and may submit a request to tracking server 133 for other clients that have data blocks that the client desires to retrieve.

Control server 131 maintains a peer list 170 that includes connectivity information, such as a network address and port number, of respective peer clients that are connected within peer-to-peer network 100. When control server 131 generates peer list 170, connectivity information of streaming source 132 may be the only connectivity information included in peer list 170. A client joins peer-to-peer network 100 by first connecting with control server 131 and submitting a request for peer list 170. The control server returns peer list 170 to the requesting client, and the client joins network 100 by selecting one or more nodes having connectivity information included in peer list 170 and connecting with the selected nodes.

When a new client joins peer-to-peer network 100, control server 132 may add connectivity information of the newly joining client to peer list 170. In this manner, as additional clients join peer-to-peer network 100, the availability of peer clients with which subsequently joining clients may connect is increased. Connectivity information of streaming source 132 may be removed from peer list 170, for example when the number of clients connected within peer-to-peer network 100 reaches a pre-defined threshold. In this manner, the streaming session load placed on streaming source 132 may be reduced. A client connected within peer-to-peer network 100 that desires streaming content originally provided by streaming source 132 may submit a query for the streaming content to peer clients with which the requesting client is connected. If no peer clients within network 100 have the requested streaming content (or no peer clients within network 100 are available for delivery of the streaming content to the requesting client), the requesting client may obtain the streaming content from streaming source 132.

In accordance with embodiments described herein, a peer client that receives streaming content from streaming source 132 may be configured to cache or temporarily store the streaming content (or a portion thereof) for playback. Additionally, a client may distribute cached streaming content to other peer clients. Streaming content may be segmented by streaming source 132 into data blocks that each have an associated sequence number. Playback of streaming content is performed by arranging data blocks into a proper sequence based on the data blocks respective sequence number. Additionally, a client may initiate playback of streaming content from an arbitrary position of the streaming content. For example, assume streaming content distributed by streaming source 132 comprises “live” streaming content, for example streaming data captured by audio/video production equipment 161 that is being transmitted to peer clients. A user may begin receiving content of the streaming session at an arbitrary position within the session by specifying a data block sequence number that corresponds to the desired position within the streaming session. In this manner, users that do not join a streaming session at the beginning of the streaming content session may initiate playback from, for example, the beginning of the streaming content.

As noted above, streaming content size, e.g., the number of bytes of streaming content, may exceed an individual client's cache capacity. To facilitate storage of streaming content that may be distributed to other peer clients, data blocks of streaming content may be stored by individual clients on a randomized basis. In this manner, the entirety of a streaming content structure may be stored by the aggregate client capacity (or a portion thereof) of a peer-to-peer network.

Network 100 may comprise a transient Internet network, and thus clients 110-117, control server 131, streaming source 132, and tracking server 133 may use the Transmission Control Protocol/Internet Protocol (TCP/IP) suite of protocols to communicate with one another. Alternatively, network 100 may be implemented in any number of different types of networks, such as for example, an intranet, a local area network (LAN), or a wide area network (WAN). Additionally, control server 131, streaming source 132, and tracking server 133 are shown as distinct entities within network 100. However, control server 131, streaming source 132, or tracking server 133 may be collectively implemented in one or more common network nodes. FIG. 1 is intended as an example, and not as an architectural limitation of embodiments described herein.

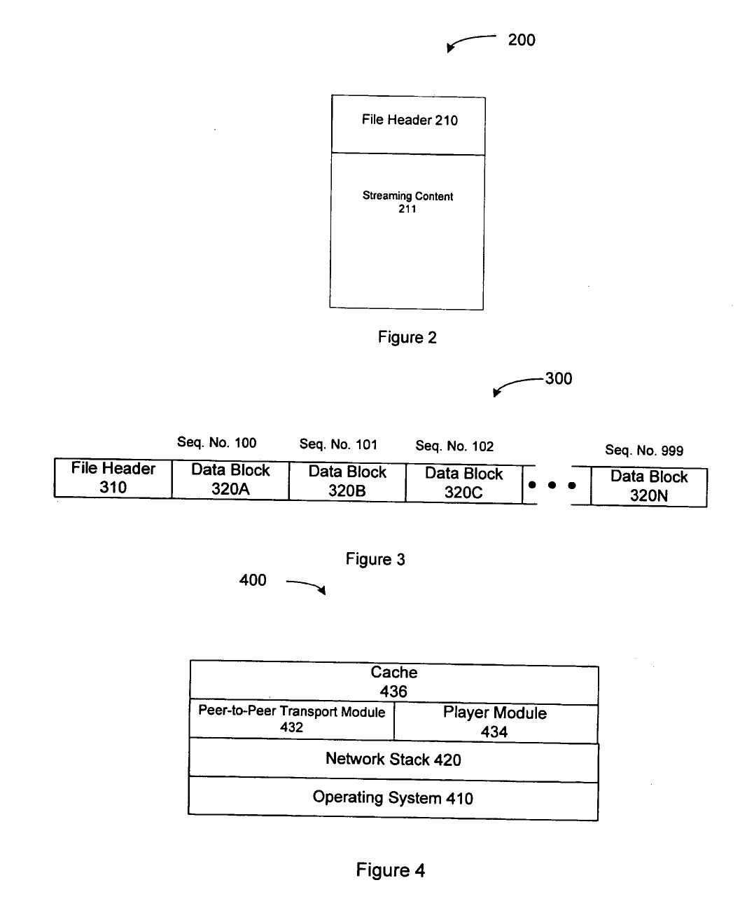

FIG. 2 is a diagrammatic representation of an embodiment of a streaming content file 200 having content that may be distributed in peer-to-peer network 100. Streaming content file 200 may include a file header 210 and streaming content 211. File header 210 may include various control or information fields that facilitate processing of streaming content 211 for proper playback thereof. For example, file header 210 may include fields that have values specifying the encoder used for encoding streaming content 211, protocol version of the streaming content data, the length of data included in streaming content file 200, or other data that may be used for playback of the streaming content. Streaming content 211 may include encoded video, audio, or other multimedia data.

Streaming content file 200 may be provided to clients from streaming source 132 (FIG. 1). For example, streaming source 132 may fetch streaming content file 200 from storage device 160 connected or otherwise interfaced with streaming source 132, or streaming content file 200 may be generated by streaming source 132 and adjunct equipment, for example from audio/video production equipment 161. In this configuration, streaming source 132, or equipment connected therewith, generates file header 210 having parameters or field values that facilitate processing of streaming content 211.

Streaming content, whether retrieved from a file or produced by audio/video production equipment or another source, may be segmented into data blocks for transmission in peer-to-peer network 100. In accordance with embodiments described herein, streaming content data blocks are associated with a sequence number to facilitate caching of streaming content within peer-to-peer network and to facilitate playback of streaming content from an arbitrary position within the streaming content.

FIG. 3 is a diagrammatic representation of an embodiment of segmented streaming content 300 formatted for transmission in a peer-to-peer network. Segmented streaming content 300 may be generated by streaming source 132 by segmenting or otherwise dividing streaming content file 200 into segments or data blocks. For example, the streaming source may extract file header 210 from streaming content file 200 and store the extracted information as a file header block 310 in a cache or other storage device. Additionally, streaming source 132 may partition or otherwise segment streaming content 211 into groups of one or more data blocks. Groups of data blocks may then be transmitted to peers connected with streaming source 132, and streaming source 132 may store data blocks 320A-320N in a local storage device. Preferably, streaming source 132 associates a respective sequence number with each data block of the streaming content. For example, streaming source 132 may insert, append, or otherwise associate one of a series of sequence numbers to each data block 320A-320N of segmented streaming content 300. In the illustrative example, each of data blocks 320A-320N have a respective sequence number 100-999 associated therewith.

A client in network 100 first receives file header block 310 prior to being able to playback any streaming content received in data blocks 320A-320N. One or more of data blocks 320A-320N may be received by the client, cached thereby, and assembled into sequential order based on data block sequence numbers for playback of the streaming content. Additionally, a client may cache one or more received data blocks 320A-320N for later transmission to other peer clients requesting the streaming content.

Client cache capacity is limited to a finite size and thus clients may periodically be required to delete one or more data blocks 320A-320N from cache. In accordance with embodiments, peer clients may store different sets of data blocks 320A-320N. Storage of different data blocks by clients within network 100 may be facilitated by, for example, a randomized selection of data blocks for deletion when a client is deleting data blocks from its cache to provide capacity for more recently received data blocks, a randomized selection routine for selecting which received data blocks to cache for later distribution to other clients, or other methods.

FIG. 4 is a diagrammatic representation of an embodiment of a software configuration 400 that facilitates playback and recording of streaming multimedia data. Software configuration 400 comprises sets of computer-executable instructions or code that may be fetched from a memory and executed by a processing unit of a data processing system. Software configuration 400 is preferably run by a peer-to-peer client, such as one or more of clients 110-117 shown in FIG. 1.

Software configuration 400 may include an operating system 410, such as a Windows operating system manufactured by Microsoft Corporation of Redmond, Wash., an OS/2 operating system manufactured by International Business Machines Corporation of Armonk, N.Y., or the like. Operating system 410 may include a network stack 420 for effecting network communications. For example, network stack 420 may be implemented as a transmission control protocol/Internet protocol (TCP/IP) stack.

Software configuration 400 may include a peer-to-peer transport module 432 that comprises logic for self-administration of the peer-to-peer network structure. For example, peer-to-peer transport module 432 may provide self-adjusting functions of the peer client location in the peer-to-peer network topology. Additionally, transport module 432 may provide network transmission and reception functions for data streams. For example, transport module 432 may supply one or more data blocks, such as data blocks 320A-320N, formatted for delivery in network 100 to network stack 420 for transmission in the peer-to-peer network. Transport module 432 may maintain socket data of peer connections, retrieval functions of data cached by the client for transmission to another client, or other functions that facilitate the client downloading or uploading media data from and to other peer clients or network nodes.

A player module 434, such as a media player application, may be included in software configuration 400 and comprises logic for processing, recording, and playback of streaming data, such as streaming video, audio, or other streaming content. Transport module 432 may be included with, or interface with, player module 434. In accordance with embodiments, player module 434 may include logic for recording or otherwise storing one or more streaming content data blocks after playback of the streaming content contained in one or more streaming content data blocks, or after receipt of the streaming content data blocks. For example, player module 434 may interface with a cache 436 that may be of a fixed size, for example 50 MB. In the event that cache 436 is consumed, player module 434 may delete older data blocks therefrom to provide capacity for more recently received data blocks. For example, player module 434 may select data blocks for deletion from cache 436 based on sequence numbers associated with cached data blocks, on a pseudo-random basis, a combination of sequence number-based deletion and pseudo-random deletion, or by another mechanism. Additionally, player module 434 may store data blocks to cache 436 on a pseudo-random basis to randomize the data blocks contained in cache 436. Accordingly, the probability of at least one client in network 100 having a particular data block is enhanced by randomizing the storage of data blocks in respective client caches.

A size of cache 436 may be predefined or may be based on a “weight of health” measure of the streaming content stored within one or more clients within peer-to-peer network 100. For example, assume streaming media of a duration T seconds is needed to be stored in peer-to-peer network 100. If a peer client has a cache 436 size of B bytes, the per user storage, Tₒ, of media data in units of time is defined as:
Tₒ=B/S, equation 1:

where S is the sample rate of the media content. Each peer client can only store a fraction To/T of the entire media content. In a peer-to-peer network having a number, N, of peer clients, the weight of health (W) of the stored data in the peer-to-peer network may be represented as:
W=(Tₒ/T)*N. equation 2:

A weight of health less than 1 indicates the system is not able to store all data blocks of the media content. An average client cache size, B, necessary to provide sufficient network storage may thus be obtained by the following:
B=W*(S*T)/N. equation 3:

Equations 1-3 are exemplary only and may be used to determine a desirable cache size for peer clients. However, other mechanisms may be used for determining client cache sizes.

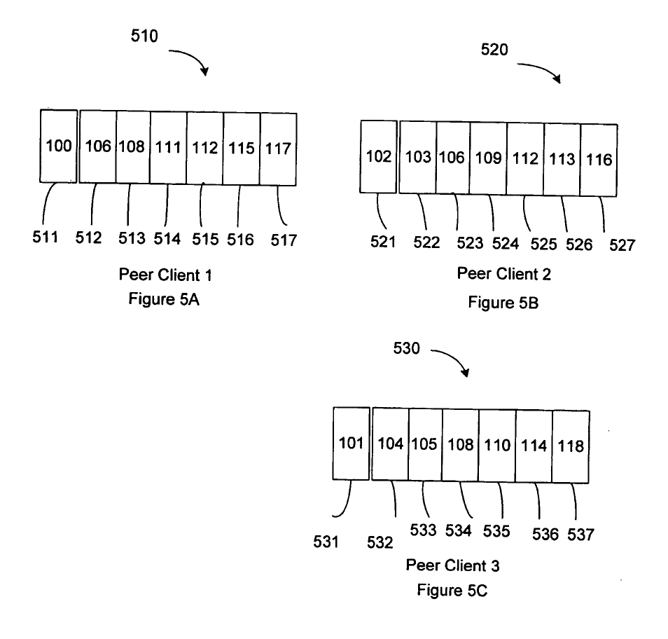

FIGS. 5A-5C are respective diagrammatic representations of an embodiment of randomized data block storage by clients of a peer-to-peer network. Three respective exemplary client cache storages 510, 520, and 530 are shown to facilitate an understanding of the embodiment. Client cache storage 410 is representative of a client cache of a first peer client (designated Peer Client 1), client cache storage 520 is representative of a client cache of a second peer client (designated Peer Client 2), and client cache storage 530 is representative of a client cache of a third peer client (designated Peer Client 3). In the illustrative example, client cache storage 510 contains streaming content data blocks 511-517 each having a respective sequence number of 100, 106, 108, 111, 112, 115, and 117. Client cache storage 520 contains streaming content data blocks 521-527 having respective sequence numbers of 102, 103, 106, 109, 112, 113, and 116. Client cache storage 530 contains streaming content data blocks 531-537 having respective sequence numbers of 101, 104, 105, 108, 110, 114, and 118. Storage of data blocks 511-517 by Peer Client 1, data blocks 521-527 by Peer Client 2, and data blocks 531-537 by Peer Client 3 may be facilitated by a pseudo-random selection routine implemented in, or interfaced with, respective player module 434 of the peer clients. Peer clients 1-3 may periodically report the particular streaming content data blocks cached thereby to tracking server 133 to facilitate recording of the distribution of streaming content within the peer-to-peer network.

Various peer clients may obtain streaming content from streaming source 132 or from other peer clients. In accordance with embodiments described herein, a peer client may specify an arbitrary position within the streaming content from which the peer client desires playback to commence. To this end, player module 434 may be adapted to receive an input that specifies a desired position, for example a time, within a streaming content at which initiation of playback is desired. The input may, for example, be provided via a user interface by way of an input device such as a mouse or keyboard. In response to receiving the input, player module 434 may calculate a streaming content data block sequence number that approximately corresponds to the desired position within the streaming content. Player module 434 may then invoke the establishment of a connection with tracking server 133 for submission of a request that specifies the streaming content and data block sequence number at which playback is desired. Tracking server 133 then interrogates a record, such as a database, of clients that have a portion or all of the desired streaming content and identifies one or more clients that have cached the data block with the desired starting sequence number. Additionally, clients having streaming content data blocks with sequence numbers within a predefined range of the desired starting data block sequence number may be identified as well. One or more of any clients identified as having the streaming content data block having the desired starting sequence number (and optionally those clients with data blocks having respective sequence numbers within the predefined range) are returned to the requesting client in the form of a peer list of the identified peer clients. Preferably, the peer list includes connectivity information of the identified peer clients and a list of sequence numbers of data blocks respectively cached by the identified peer clients.

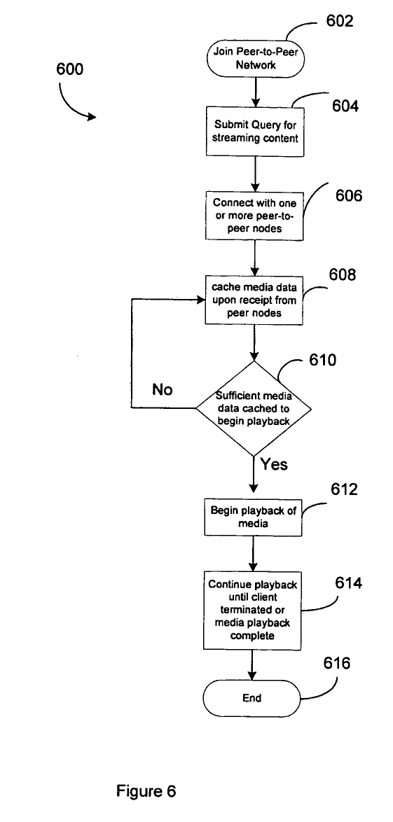

FIG. 6 is a flowchart of an embodiment of a peer client processing routine for playback of streaming media content received in a peer-to-peer network. The client processing routine begins upon the peer client joining the peer-to-peer network, for example by establishing a connection with one or more peer nodes such as other peer clients or a streaming source (step 602). The client may submit a query in the peer-to-peer network for streaming content (step 604). The client then connects with one or more peer nodes that have at least a portion of the requested streaming content (step 606) and receives streaming content data blocks therefrom. The client may cache media data blocks upon receipt thereof (step 608). An evaluation may be performed by the client to determine whether sufficient media data blocks have been cached to initiate playback of the streaming content (step 610). In the event that a sufficient number of streaming media data blocks have not been received, the client continues caching media content as the media data blocks are received according to step 608.

When the client has accumulated sufficient media data as determined at step 610, the client may then initiate playback of the media content (step 612). Playback of the streaming content is continued until the client terminates playback or until playback of the streaming content is complete (step 614). The client processing cycle may then end (step 616).

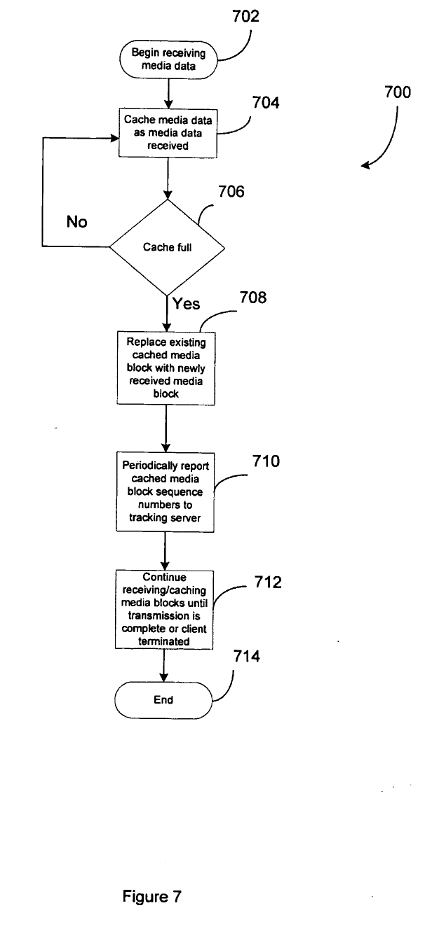

FIG. 7 is a flowchart of an embodiment of peer client processing routine for caching received streaming content in a peer-to-peer network. Peer client processing of streaming content begins upon receipt of streaming media data (step 702). The peer client may cache streaming content data blocks, or a portion thereof, received in the peer-to-peer network (step 704). For example, the client may cache all received media data blocks is the client's cache has available capacity. Alternatively, received media data blocks may be selected for caching on a pseudo-random basis. A periodic evaluation of the peer client cache may be made to determine if the cache is full (step 706). In the event the cache has remaining capacity, the client continues to receive and cache media content according to step 704. If the cache is evaluated as full at step 706, the client may then begin deleting or otherwise replacing previously cached media content data blocks with the most recently received media content data blocks (step 708). Media data blocks that are deleted to provide capacity in the cache for more recently received data blocks may be selected for deletion based on respective sequence numbers of the data blocks. For example, media data blocks with the most antiquated sequence numbers stored in cache may be selected for deletion. Alternatively (or additionally), media data blocks may be selected for deletion based on a pseudo-random selection routine in order to randomize the particular data blocks maintained in the client's cache. Additionally, each received media data block may be subjected to a randomization selection process for determining whether to cache the received data block to further facilitate randomization of the data blocks cached by the client. The client preferably makes a periodic report to the tracking server that identifies the sequence numbers of media data blocks cached by the client (step 710). The client continues receiving and caching media data blocks until the receipt of the media transmission is complete, the client is terminated, or receipt of the media transmission is otherwise terminated (step 712). The client media caching process may then end (step 714).

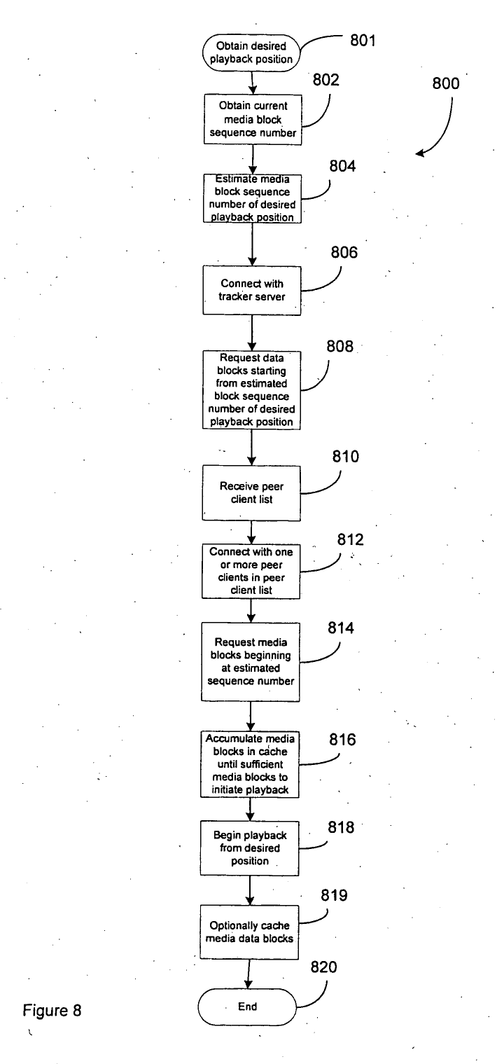

FIG. 8 is a flowchart of an embodiment of a peer client processing routine for playback of streaming content from an arbitrary position of the streaming content in a peer-to-peer network. Client processing for playback of streaming content at an arbitrary positions begins by the client obtaining a desired playback position within a streaming media content (step 801). For example, the desired playback position may be specified by a time within a streaming media transmission such as a time at which a streaming transmission was begun or another indication that provides a reference position from a desired position within a media transmission to a current position of the media transmission. The desired playback position may be provided to player module 434 by way of a user input provided to the client or another suitable mechanism. The client may then determine a media data block sequence number that corresponds to the current position of the media transmission, i.e., the most recent media data block sequence number transmitted in network 100 (step 802). An estimation of a media data block sequence number that corresponds to the desired playback position may then be determined (step 804). For example, media data blocks may be encoded an a predefined sample rate and thus provide a particular duration of media playback per media data block. Thus, the client can determine an approximate number of data blocks between the desired playback position and the current position of the media session and derive a sequence number for the desired playback position therefrom. Other mechanisms may be used for determining an approximate sequence number that corresponds to the desired playback position.

Once the client has determined a sequence number that corresponds to the desired playback position, the client may connect with the tracking server (step 806) and submit a request for a peer list of clients that have the media block with the desired sequence number (step 808). The client then awaits receipt of a peer list from the tracking server (step 810). The client may then connect with one or more peer clients in the peer list (step 812) and submit a request for media data blocks beginning at the desired sequence number (step 814). The client then begins receiving media data blocks from the peers and accumulating data blocks for playback of the media (step 816). Once sufficient media data blocks have been accumulated, the client may begin playback of the media from the desired position (step 818). Optionally, the client may store the received media data blocks to a storage device if recording of the media content from the playback position is desired (step 819). For example, a user may provide an input to player module 434 that recordation of the streaming content is desired. The client processing routine for media playback from an arbitrary position may then end (step 820).

As described, embodiments provide a method and computer-readable medium for storing content in a peer-to-peer network. A client of a peer-to-peer network receives a plurality of data blocks that respectively include a portion of the content. One or more of the plurality of data blocks are pseudo-randomly selected. The selected data block is then stored. Thus, content storage in a peer-to-peer network is randomized to advantageously exploit the aggregate client storage capacity of the peer-to-peer network. In other embodiments, a method and computer-readable medium for playing streaming content in a peer-to-peer network is provided. A desired playback position of the streaming content is obtained. A first sequence number of a current data block of the streaming content is obtained. An estimation of a second sequence number that corresponds to the desired playback position is made. A connection with a peer client having a data block with the second sequence number associated therewith is made and the data block is received from the peer client.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of storing content in a peer-to-peer network, comprising:
receiving, by a client of the peer-to-peer network, a plurality of data blocks that respectively include a portion of the content;
pseudo-randomly selecting one or more of the plurality of data blocks; and
storing the one or more data blocks.

2. The method of claim 1, wherein receiving the plurality of data blocks further comprises receiving a plurality of data blocks that respectively include a portion of streaming content.

3. The method of claim 2, wherein receiving the plurality of data blocks further comprises receiving the plurality of data blocks each having a respective sequence number associated therewith.

4. The method of claim 1, further comprising reporting to a node in the peer-to-peer network an identity of the one or more data blocks.

5. The method of claim 4, wherein reporting further comprises reporting respective sequence numbers of the one or more data blocks to the node.

6. A method of managing a client cache in a peer-to-peer network, comprising:
receiving a first data block for storage in the client cache;
determining whether the client cache capacity is full;
pseudo-randomly selecting a second data block in the client cache for deletion;
deleting the second data block; and
storing the first data block in the client cache.

7. The method of claim 6, wherein pseudo-randomly selecting the second data block further comprises:
evaluating a plurality of sequence numbers each respectively associated with one of a plurality of data blocks in the client cache; and
selecting the second data block based on the sequence number of the second data block.

8. A method of playing streaming content in a peer-to-peer network, comprising:
obtaining a desired playback position of the streaming content;
obtaining a first sequence number of a current data block of the streaming content;
estimating a second sequence number that corresponds to the desired playback position;
connecting with a client in the peer-to-peer network that has a data block with the second sequence number associated therewith; and
receiving the data block with the second sequence number from the client.

9. The method of claim 8, further comprising:
connecting with a node of the peer-to-peer network;
submitting a request for an identity of one or more clients that have the data block with the second sequence number; and
receiving a peer list of peer clients that includes connectivity information of the one or more clients.

10. The method of claim 9, wherein receiving the peer list further comprises receiving the peer list that includes connectivity information of the one or more clients that includes at least one client with one or more data blocks having respective sequence numbers within a pre-defined range of the second sequence number.

11. The method of claim 8, wherein connecting with the client further comprises connecting with a plurality of clients that each have one or more data blocks within a pre-defined range of the second sequence number.

12. A computer-readable medium having computer-executable instructions for execution by a processing system, the computer-executable instructions for storing content in a peer-to-peer network, comprising:
instructions that receive a plurality of data blocks that respectively include a portion of the content;
instructions that pseudo-randomly store one or more of the plurality of data blocks in a client cache.

13. The computer-readable medium of claim 12, wherein the instructions that receive the plurality of data blocks receive a plurality of data blocks that respectively include a portion of streaming content.

14. The computer-readable medium of claim 13, wherein the instructions that receive the plurality of data blocks receive the plurality of data blocks each having a respective sequence number associated therewith.

15. The computer-readable medium of claim 12, further comprising instructions that report an identity of the one or more data blocks to a node in the peer-to-peer network.

16. The computer-readable medium of claim 12, wherein the plurality of data blocks include a first data block for storage in a client cache, wherein the instructions that pseudo-randomly store one or more of the plurality of data blocks in the client cache further comprise:
instructions that determine the client cache capacity is full;
instructions that pseudo-randomly select a data block in the client cache for deletion;
instructions that delete the data block in the client cache; and
instructions that store the first data block in the client cache.

17. The computer-readable medium of claim 16, wherein the instructions that pseudo-randomly select the data block further comprises:
instructions that evaluate a plurality of sequence numbers each respectively associated with one of a plurality of data blocks in the client cache; and
instructions that select the data block in the client cache based on a sequence number of the data block in the client cache.

18. A computer-readable medium having computer-executable instructions for execution by a processing system, the computer-executable instructions for playing streaming content in a peer-to-peer network, comprising:
instructions that obtain a desired playback position of the streaming content;
instructions that obtain a first sequence number of a current data block of the streaming content;
instructions that estimate a second sequence number that corresponds to the desired playback position;
instructions that connect with a client in the peer-to-peer network that has a data block with the second sequence number associated therewith; and
instructions that receive the data block from the client.

19. The computer-readable medium of claim 18, further comprising:
instructions that connect with a node of the peer-to-peer network;
instructions that submit a request for an identity of one or more clients that have the data block with the second sequence number; and
instructions that receive a peer list of peer clients that includes connectivity information of the one or more clients.

20. The computer-readable medium of claim 19, wherein the peer list includes connectivity information of the one or more clients including at least one client with one or more data blocks having respective sequence numbers within a pre-defined range of the second sequence number.

21. The computer-readable medium of claim 18, wherein the instructions that connect with the client connect with a plurality of clients that each have one or more data blocks within a pre-defined range of the second sequence number.
